(19) United States
(12) Patent Application Publication
(10) Pub. No.: US 2015/0115041 A1
(43) Pub. Date: Apr. 30, 2015

(54) self-power generation RFID tag

(71) Applicant: TianJin Orient Navigation Science Develope Ltd,. Company, Tianjin (CN)

(72) Inventor: Wenjie ZHANG, Tianjin (CN)

(73) Assignee: TianJin Orient Navigation Science Develope Ltd,., Tianjin (CN)

(21) Appl. No.: 14/064,204

(22) Filed: Oct. 28, 2013

(51) Int. Cl. G06K 19/07

(52) U.S. Cl. CPC G06K 19/0704
USPC 235/492

(57) ABSTRACT

Disclosed in the present invention is a self-power generation radio frequency identification (RFID) tag, which comprises an identifier in which a first coil and a magnetic power generation bar are arranged, wherein the first coil is movably arranged in the identifier, and the magnetic power generation bar is arranged in parallel to the plane of the first coil; and the RFID tag also comprises a micro storage battery, which is electrically connected with the induction coil and the magnetic power generation bar. The self-power generation RFID tag is simple in structure, low in cost, convenient to maintain, energy-saving and environment-friendly.

### BACKGROUND OF THE INVENTION

1. Field of the Invention

The present invention relates to a self-power generation RFID tag.

2. Background of the Invention

Radio frequency identification (RFID) is a noncontact automatic identification technology and is used for automatically identifying a target object through radio frequency signals and acquiring related data, and the identification work does not need manual intervention and can be applied to various severe environments. The RFID technology can be used for identifying a high-speed moving object and simultaneously identifying a plurality of electronic tags, and is fast and convenient to operate. RFID tags are divided into passive, semi-passive (also known as semi-active) and active tags, common passive tags are not provided with power supplies, and the semi-passive and active tags provided with power supplies are short in working time and higher in maintenance cost.

### BRIEF SUMMARY OF THE INVENTION

The present invention aims to overcome the defects of the prior art and provides a self-power generation RFID tag which is simple in structure, low in cost, convenient to maintain, energy-saving and environment-friendly.

For solving the aforementioned problems, disclosed in the present invention is a self-power generation RFID tag, characterized by comprising:

an identifier in which a coil and a magnetic power generation bar are arranged, wherein the coil is movably arranged in the identifier, and the magnetic power generation bar is arranged in parallel to the plane of the coil;

and a micro storage battery, which is electrically connected with the coil and the magnetic power generation bar.

Preferably, the self-power generation RFID tag also comprises:

an RFID chip, which is provided with an input/output end, wherein the input/output end is connected with the coil, and the chip is connected with an antenna;

and a circuit.

Preferably, the circuit is suitable for receiving power from the micro storage battery and works based on the received power.

Preferably, the self-power generation RFID tag also comprises a standby battery and an insufficient power alarm device.

The present invention has the beneficial effects that the RFID tag is used in a container, the rocking power of the container in the transportation process is converted into current by using the principle that electromagnetic induction generates current, the current is supplied to the circuit of the tag to run, the electrical energy of the whole transportation process can be supplied to the tag, and the tag provided with the additional standby battery can continuously run for 25 days after an insufficient power alarm is given, so the electricity for the tag can be substantially guaranteed and never fails. In conclusion, the self-power generation RFID tag is simple in structure, low in cost, convenient to maintain, energy-saving and environment-friendly.

### BRIEF DESCRIPTION OF THE DRAWINGS

FIG. 1 is a structural schematic view of a self-power generation RFID tag of the present invention.

### DETAILED DESCRIPTION OF THE INVENTION

The present invention is further illustrated in details below in conjunction with the drawing to enable those skilled in the art to implement the present invention with reference to the characters of the specification.

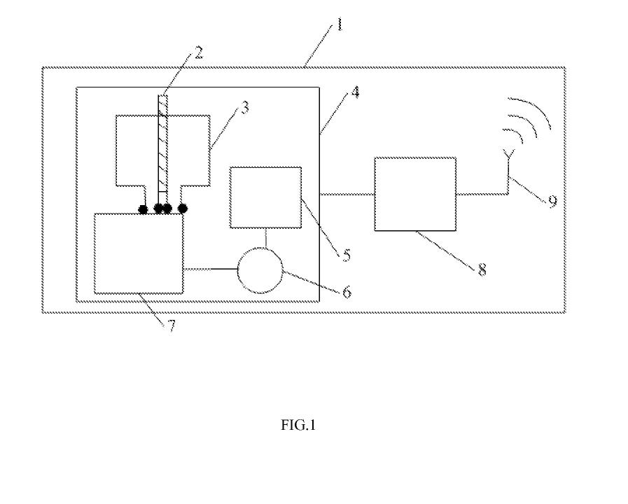

As shown in FIG. 1, the self-power generation RFID tag comprises:

an identifier 4 in which a coil 3 and a magnetic power generation bar 2 are arranged, wherein the coil 3 is movably arranged in the identifier 4, and the magnetic power generation bar 2 is arranged in parallel to the plane of the coil 3; a micro storage battery 7, which is electrically connected with the coil 3 and the magnetic power generation bar 2; an RFID chip 8, which is provided with an input/output end, wherein the input/output end is connected with the coil, and the chip 8 is also connected with an antenna 9; a circuit; a standby battery 5; and an insufficient power alarm device 6. The standby battery 5 is electrically connected with the circuit; the insufficient power alarm device 6 is electrically connected with the storage battery 7; and when the power of the storage battery 7 is insufficient, the insufficient power alarm device 6 gives an alarm and the standby battery 5 is activated to supply power to the circuit. The circuit is suitable for receiving power from the micro storage battery 7 and works based on the received power.

The implementation schemes of the present invention are disclosed above, but are not limited in the specification and the application listed in the embodiments, and the implementation schemes can be applied in various fields suitable for the present invention. Those skilled in the art could readily realize additional modifications. Therefore, the present invention is not limited in specific details and the drawing shown and described here without departing from common concepts limited by the claims and equivalent range.

What is claimed is:

1. A self-power generation RFID tag, characterized by comprising:
an identifier in which a coil and a magnetic power generation bar are arranged, wherein the coil is movably arranged in the identifier, and the magnetic power generation bar is arranged in parallel to the plane of the coil;
and a micro storage battery, which is electrically connected with the coil and the magnetic power generation bar.

2. The self-power generation RFID tag according to claim 1, characterized by also comprising:
an RFID chip, which is provided with an input/output end, wherein the input/output end is connected with the coil, and the chip is connected with an antenna;
and a circuit.

3. The self-power generation RFID tag according to claim 2, characterized in that the circuit is suitable for receiving power from the micro storage battery and works based on the received power.

4. The self-power generation RFID tag according to claim 1, characterized by also comprising:
a standby battery;
and an insufficient power alarm device.
